(19) United States
(12) Patent Application Publication
(10) Pub. No.: US 2014/0281917 A1
(43) Pub. Date: Sep. 18, 2014

(54) REVIEW PORTAL

(71) Applicant: Advanced Medical Reviews, Inc., Los Angeles, CA (US)

(72) Inventors: Eytan J. Alpern, Los Angeles, CA (US); Wesley Kinnett, Odessa, FL (US)

(73) Assignee: Advanced Medical Reviews, Inc., Los Angeles, CA (US)

(21) Appl. No.: 14/209,957

(22) Filed: Mar. 13, 2014

Related U.S. Application Data
(60) Provisional application No. 61/799,142, filed on Mar. 15, 2013.

(51) Int. Cl. G06F 17/22

(52) U.S. Cl. CPC G06F 17/2247
USPC 715/234

(57) ABSTRACT

In an example, a system is provided to render a form, e.g. a medical review form, dynamically. In an example, the system retains a collection of fields. Fields may be selected from the collection to form a template, e.g. a review template. A customized electronic form may be dynamically rendered based on the template for display in a browser.

### PRIORITY

This application claims benefit of U.S. Provisional Application No. 61/799,142 filed on Mar. 15, 2013, entitled: REVIEW PORTAL, which is herein incorporated by reference in its entirety.

### COPYRIGHT NOTICE

© 2014 Advanced Medical Reviews, Inc. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### BACKGROUND OF THE INVENTION

Independent medical reviews are known. A customer/client provides medical information, e.g. medical records, medical billing records, etc. to an independent reviewer, who may provide an opinion on a quality of a medical service and/or a cost/billing of the medical service.

Electronic forms may be involved in the process of obtaining a medical review. For example, an electronic form may be provided to the customer/client to collect the medical information. Some known systems for generating the electronic forms involve hard coding an electronic form based on the particular service required by a client.

### SUMMARY OF THE INVENTION

The following is a summary of the invention in order to provide a basic understanding of some aspects of the invention. This summary is not intended to identify key/critical elements of the invention or to delineate the scope of the invention. Its sole purpose is to present some concepts of the invention in a simplified form as a prelude to the more detailed description that is presented later.

In an example, a system is provided to render a form, e.g. a medical review form, dynamically. In an example, the system retains a collection of fields. Fields may be selected from the collection to form a template, e.g. a review template. A customized electronic form may be dynamically rendered based on the template for display in a browser.

The system may provide portions of the form to three or more parties. In an example, a first party includes a staff of the medical review organization, a second party includes a client of the medical review organization, and a third party includes a professional that is independent of the staff, such as a medical professional, e.g. a physician, that is independent of the staff. In an example, the system is configured to retain a plurality of predefined review stage types for the review. A first review stage type of the plurality may correspond to the first party, a second review stage type may correspond to the second party, and a third review stage type may correspond to the third party. The system may be configured to form a workflow definition responsive to receiving a user input for a custom workflow. The workflow definition may identify selected ones of the stage types of the plurality, and a selected order for executing a process based on the selected ones of the stages types of the plurality.

In an example, at least one of the review stage types of the plurality may include a dispatch stage to select at least one individual of the third party. The dispatch stage may include filtering, to select a subset from a set of professionals based on a parameter set by the second party. Examples of the parameter include physicians working a threshold number of hours a week, practicing surgeons, physicians licensed in a particular stage, physicians that completed a particular training program, or the like, or combinations thereof. In an example, the dispatch stage may include grouping, to divide the subset resulting from the filtering into a plurality of groups based on a parameter set by the first party. In an example, the dispatch stage may include scheduling, including notifying members of a first group of the plurality at a first time regarding a review assignment and notifying the members of a second group of the plurality that is different than the first group at a second time that is different than the first time. In an example, the second time may be the earlier of a fixed date and time or a date and time that every member of the first group explicitly rejects the review assignment.

Additional aspects and advantages of this invention will be apparent from the following detailed description of preferred embodiments, which proceeds with reference to the accompanying drawings.

### BRIEF DESCRIPTION OF THE DRAWINGS

FIG. 1A illustrates a system to dynamically render a form.

FIG. 1B illustrates a flow chart showing operation of the processing device 13 of FIG. 1A.

FIGS. 2A and 2B illustrate a diagram showing an example render process.

FIGS. 3A and 3B illustrate an example display of a portal admin section of an example review portal.

FIG. 4 illustrates an example of a group assignment for dispatch scheduling.

FIG. 5 illustrates an example process for a review field save operation.

FIG. 6A illustrates a client workflow for a review resubmission.

FIG. 6B illustrates modified code for the client workflow of FIG. 6A.

FIG. 6C illustrates a reviewer/processor workflow for a review resubmission.

FIG. 6D illustrates modified code for the reviewer/processor workflow of FIG. 6C.

FIGS. 6E and 6F illustrate a billing workflow for a review resubmission.

FIG. 6G illustrates modified code for the billing workflow.

FIG. 6H illustrates an invoicing summary for a review resubmission.

### DETAILED DESCRIPTION OF PREFERRED EMBODIMENTS

FIG. 1A illustrates a system to dynamically render a form.

The system 100 includes a network device 11 to provide a dynamically rendered form, e.g. a medical review form, to be displayed by a browser 10 of a remote device 9. The network device 11 includes a processing device 13 to dynamically render the form based on information of a storage device 19, which may be located locally or remotely with respect to the network device 11. In an example, the remote device 9 is a known terminal, such as a desktop computer, a mobile device, or the like. In an example, the browser 10 is a known browser.

In an example, the storage device 19 may store a plurality of fields 15. The storage device 19 may store a plurality of templates 17, e.g. at least a first combination of the fields and a second different combination of the fields. Each template may include at least one standard field and/or at least one custom field (a set of standard fields may be provided, and a custom field may be generated for use by a corresponding customer/client by modifying one of the standard fields).

Processing device 13 may be configured to perform a render process on each field of a selected template. One example of a per-field rendering process is illustrated in FIGS. 2A-2B, which will be explained later in greater detail. Processing device 13 may transmit a first set 12 of rendered fields to the remote device 9 to cause a web page including a review form to be displayed via the browser 10.

When a user of the remote device 9 inputs data into one of the fields of the webpage, the processing device 13 may receive an upload 14 based on the input data. The processing device 13 may selectively re-render the fields of the selected template responsive to receiving the input data. The selective re-rendering may be performed for only a subset of the fields of the template, e.g. the field corresponding to the update and fields determined to be dependent, directly or indirectly, on the corresponding field. Re-rending may be according to the per-field rendering process is illustrated in FIGS. 2A-2B. For example, the process of FIGS. 2A-2B may be re-executed for the subset of the fields associated with the user input.

In an example, the processing device 13 may maintain per-field dependency lists. Each list may be generated when the field is rendered. In an example, the rendering may involve parsing code of the field, e.g. parse JavaScript, and the list may be generated responsive to a result of parsing the code. The generated list may be retained and accessed during re-rendering of a corresponding field. During re-rending of the corresponding field, dependent fields indicated by the corresponding list may identify other ones of the retained lists, which may identify yet more corresponding lists, etc. In an example, the processing device 13 may be configured to stop identifying lists in the instance of a circular reference.

In an example, the code is of a free form JavaScript text box. Within that JavaScript, a template manager may enter a field name. Responsive to saving the field within the template manager, the processing device 13 may parse out all of the text boxes to determine whether any known field names are included. The processing device 13 may add the field names to a dependency list.

The processing device 13 may transmit a second set 16 of rendered fields to the remote device 9 to cause the web page including the review form to change. The experience from the point of view of the user of the browser 10 is that a review form may dynamically change as they interact with the review form. Fields may appear and disappear as the user inputs data (based on processing device 13 selectively re-processing fields). Fields may change in appearance and/or functionality (based on re-rendering).

In an example, the system 100 includes a memory device having instructions stored thereon that, in response to execution by a processing device, cause the processing device to perform operations. In an example, the operations include storing a plurality of fields for forming an electronic medical review form, storing a plurality of templates, wherein a first one of the templates comprises a first set or subset of the fields of the plurality, and a second one of the templates comprises a second set or subset of the fields of the plurality, wherein the second set or subset is different than the first set or subset, selecting a template of the plurality of templates, and generating a web page using fields of the selected template.

FIGS. 2A-2B illustrate a flow chart showing operation of an example processing device in a render process.

In block 203, the processing device 13 may retrieve a field of the selected template. In diamond 205, the processing device 13 may determine whether the field is visible. Visibility may be determined based on a per-workflow-stage basis, e.g. a field may be not be visible in a first stage of a workflow, but be visible in a second stage that is different than the first stage.

In an example, visibility may be determined based on executing code of the field, e.g. parse JavaScript. At render time, the code may be executed resulting in a true or a false value(s), e.g. return true or false for each value of, say, six values. One of the values may correspond to visibility. The code may check a condition, such as which review stage type of a plurality of review stage types corresponds to a current stage, which party of a plurality of parties is reviewing the field, a status of a related field (e.g. a visibility of a related field), or the like, or combinations thereof. In an example, visibility may be determined responsive to returning true for a corresponding value that is associated with the code.

If it is determined that the field is to be visible, then in diamond 207 the processing device 13 may determine whether the field is read only. In an example, the read only determination is based on executing code of the field, e.g. parse JavaScript. Similar to the code corresponding to the visibility determination, a condition may be checked, such as which review stage type of a plurality of review stage types corresponds to a current stage, which party of a plurality of parties is reviewing the field, a status of a related field (e.g. a visibility of a related field), or the like, or combinations thereof.

If the field is determined to be read only, then in block 208 the processing device 13 may render 215 the field based on a read only attribute 208. The field may be rendered out as a label, e.g. flat text that is non-modifiable.

If the field is determined to not be read only, then in diamond 209 the processing device 13 determines whether if the field is to be required. In an example, a field may be required to be completed in order to complete a review stage and/or a medical review form.

In diamond 210, the processing device 13 may determine whether to validate the information input into the field using a validator, e.g. a custom validator. In an example, a custom validator may comprise code, e.g. JavaScript code. The custom validator may be configured to check whether user-entered data input into the corresponding field is valid, and if not, cause a corresponding error message to be generated, which may prompt a user to check an entered value and/or enter a different value.

In block 215, processing device 13 may be configured to render the field. In an example, rendering the field includes the process shown in FIG. 2B. Referring to FIG. 2B, in block 253 the processing device 13 may retrieve a data value corresponding to a field from a database. In an example, the database retains information entered on a review form, and may be updated as a user leaves/exits a field of the review form.

In block 255, the processing device 13 may be configured to calculate value, e.g. parse JavaScript, for the field. In an example, even though the data value is retrieved from the database, the block 255 may involve pre-processing to substitute the data value from the database with a different value. In an example, block 255 may include processing a logic statement, e.g. JavaScript, corresponding to the field, and the processing may utilize a value of another field in order to populate data such as a number, a formula, a sentence, a paragraph, a date and/or time, a drop down list of options, a calculation, or the like, or combinations thereof. In an example, block 255 may include calculating a value for the field by feeding value(s) of other fields into a logic statement associate with the field to determine what to show in the field. For example, the output of the logic statement may be a sum of values of other fields, a product of values of other fields, or the like, or combinations thereof.

In diamond 257, the processing device 13 may determine whether to render the field as label only. If the processing device 13 determines to render the field as label only, the field may be rendered full width, as if the field were text, e.g. standard web page text. If the processing device 13 determines to not render the field as label only, then the field may not be rendered full width, and the processing device 13 may perform one or more of the determinations 261, 263, 265, 267, and 269. Depending on which one of the determinations 261, 263, 265, 267, and 269 returns a “yes”, the processing device 13 may render data of the field as a label (262), render a numeric editor (264), render a date editor (266), render a text editor (268), or render a timespan editor (270).

Processing device 13 may be configured to transmit rendered fields to the remote device 9 to cause a web page based on the rendered fields to be displayed by browser 10. If a user makes a modification of one of the fields using the browser 10, the network device 11 may receive an upload corresponding to the modification. The processing device 13 may update the database corresponding to the upload. Responsive to updating the database, processing device 13 may selectively perform the processes of FIGS. 2A and 2B on fields of the selected template, e.g. may perform the processes on only some of the fields (i.e. the modified field and any dependent fields obtained using one or more depths of the dependency lists). The processing device 13 may be configured to transmit, e.g. transmit via pushing, to the remote device 9 fields responsive to the re-processing. The transmission responsive to re-processing may cause fields to appear or disappear on a user's screen and/or for fields to be rendered differently based on selective re-rendering.

FIG. 1B illustrates a flow chart showing operation of the processing device 13 of FIG. 1A.

In block 101, the processing device 13 may select a template of a plurality of templates. The selection may be based on a user input.

In block 102, the processing device 13 may pass each field of the selected template through a rendering process. In an example, block 102 may include retrieving one of the fields of the selected template, determining whether to render the retrieved field, and, in response to determining to render the retrieved field, selecting an attribute from a plurality of attributes and rendering the retrieved field based on the selected attribute. In an example, the plurality of attributes includes at least one of a read only attribute, a required field attribute, or a validator attribute. In an example, the attribute selection may be based on which stage of a plurality of review stage types corresponds to a current stage.

In an example, block 102 may include determining whether a last field of the selected template has been retrieved, in response to determining that the last field of selected template has not been retrieved, retrieving a next field of the selected template, determining whether to render the retrieved next field, and, in response to determining to render to retrieved next field, selecting the same or different attribute from the plurality of attributes and rendering the retrieved field based on the selected same or different attribute.

In an example, block 102 may include parsing code corresponding to a retrieved field. In an example, block 102 may include determining whether to render the retrieved field as label only responsive to a result of parsing the code of the retrieved field, and responsive to determining to not render as label only, re-rendering data of the retrieved field as a label or selecting an editor from a plurality of editors and performing the rending of said field based on the selected editor. In an example, the plurality of editors includes at least one of a numeric editor, a date editor, a text editor, or a timespan editor.

In block 103, the processing device 13 may transmit rendered fields resulting from passing each field of the selected template through the rendering process. In block 104, processing device 13 may receive a user input from a browser after transmitting the rendered fields.

In block 105, the processing device 13 may select fields of the selected template to re-pass through the rendering process. In an example, the processing device 13 may identify a field (of the selected template) that corresponds to the received user input. The processing device 13 may parse code corresponding to the selected field. The processing device 13 may, responsive to parsing the code, determine whether other field(s) of the selected template is/are dependent on the identified field. In response to determining that other field(s) of the selected template is/are dependent on the identified field, the processing device 13 may parse code corresponding to each of the other field(s). The processing device 13 may, responsive to parsing the code corresponding to each of the other field(s), determine whether to parse code based on dependencies of the other field(s).

In block 106, the processing device 13 may transmit rendered fields resulting from re-passing each of the selected fields through the rendering process.

### Review Templates

As every client may have a different format for the reviews, each review may be presented using a customizable template. A template may contain all the fields that are presented to the user for a review. It also may contain other settings that affect the logic and processing of a review. A client may have more than one template available for its reviews but a review may only use on template at a time. A review's template may be automatically changed based on other field changes and logic defined within a template. In addition to the core set of properties that all reviews share such as due date and review ID, a template may define customized fields for each review that need not be present in any other review template. The core element of a review template may be a template field. A template field may define the properties for each field on a review such as data type, location, and display name. Each template field may have several attributes that allow advanced logic via JavaScript expressions using review field variables.

Template field logic-based attributes may include:
Field visibility based on workflow stage, user roles, or custom JavaScript expression.
Field required validation based on workflow stage or custom JavaScript expression.
Default field values based on static values or custom JavaScript expression.
Drop-down field items based on static values or custom JavaScript expression.
Custom field validation upon workflow stage submission based on JavaScript expression. Both the validation rule as well as the validation message can be defined via separate JavaScript expressions.
Automated filtering rules for eligible reviewers.
Associated automated billing rules.

In addition to these logic-based attributes, template fields may also be defined as computed fields and use a complex JavaScript expression to compute its value as other fields or variables change throughout the review. Using these computed fields, the processing device 13 may accurately and automatically calculate Pharmaceutical values such as Morphine Equivalent Dosage based on medication name as well as delivery route and length of time on medication. The processing device 13 may identify multiple drugs on a review in the same class and warn accordingly.

The processing device 13 may recognize specific medical services (such as medications, medical procedures, etc) and provide relevant information to the users regarding those medical services. This information may also be customized per template.

Template fields may also be marked as containing private health information (PHI) which causes the field data to be masked on any unsecured correspondence or web pages.

### Customizable Review Workflow

Each review may have a workflow system that allows specific review stages, e.g. review stage types, to be chosen, ordered, and executed on a template-by-template basis. Workflows may be shared among many templates and each template may additionally dynamically change the workflow based on field logic on that template. For example, the next required stage in a review's workflow may change depending on the value in a field such as “Escalate Review”. This may allow for a decision tree path of stages through which a review is routed. These review workflows may be created, managed, and assigned to review templates via the Portal admin section (shown in FIG. 3A).

The entire required workflow for a review may be displayed across the top of the review along with current stage highlighted and any previous stages also shown differently (FIG. 3B), e.g. shown in a separate color.

The user may submit to any stage simply by clicking on that stage's box in this workflow diagram. The system 100 may include any number of different stage types that will determine who is eligible to complete that stage (i.e. client, administrative staff, review coordinators, senior review coordinators, reviewers, clinical staff, etc.). The system 100 may define which types of stage are in the workflow, how many stages, in which order they occur, and which stages are required vs. optional.

A review may move along this workflow based on customized automated logic. For example, if a review is marked as needing more information from the client, the processing device 13 may automatically cause an email to be sent to the appropriate party, and if nothing has changed on the review after a predetermined time, e.g. 3 days, it can be routed to an appropriate stage for action, or simply moved further along the workflow.

At each stage in a workflow, one or more stage documents may be created using document templates that may be selected based on user-definable stage and template settings. These documents may be automatically sent to clients, reviewers, or staff. The document templates may contain graphics as well as other complex objects (Excel charts for example).

In an example, the processing device 14 may be configured to store a plurality of review stage types. A first stage type of the plurality may correspond to a first party, a second stage type of the plurality may correspond to a second party that is different than the first party, and a third stage type of the plurality may correspond to a third party that is different than the first party and the second party. The first party may comprise staff of the medical review organization, the second party may comprise a client of the medical review organization, and the third party may comprise professionals that are independent of the staff. The plurality of review stage types may include review stage types of an extensible set, and the workflow definition data may be based on an extensible set version that corresponds to a time of receipt of the user input.

The processing device 13 may form a workflow definition responsive to receiving a user input for a custom workflow, the workflow definition data identifying selected ones of the stage types of the plurality and a selected order for executing a process based on the selected ones of the stage types of the plurality.

The processing device 13 may associate the workflow definition data with the selected template, retrieve a field of the selected template, and determine whether to render the retrieved field on a per-stage basis.

As will be explained in greater detail later, at least one stage of the plurality may include a dispatch stage to select at least one individual of the third party, and wherein the dispatch stage comprises filtering, to select a subset from a set of medical professionals based on a parameter set by the second party. The dispatch stage may include grouping, to divide the subset resulting from the filtering into a plurality of groups based on a parameter set by the first party. The dispatch stage may include scheduling, including notifying members of a first group of the plurality at a first time regarding a review assignment and notifying the members of a second group of the plurality that is different than the first group at a second time that is different than the first time. The second time may be the earlier of a fixed date and time or a date and time that every member of the first group explicitly rejects the review assignment.

### Review Dispatching

Review Dispatching describes the process whereby reviewers are assigned reviews; either as a primary reviewer or as one of several cosign reviewers. When a reviewer is assigned to review, he or she is automatically notified and can either accept or reject the review, though he or she may also defer the decision.

During dispatching of a review the processing device 13 may filter the available reviewers by a number of criteria that is configurable per client and review template. In an example, a criterion may be a logic statement such as include only independent reviews, for example only physicians, in a limited geographical area corresponding to the client, e.g. a same state as the client. The logic statement may be associated with the template for the client.

Using these criteria, groups of potential reviewers may be auto-assigned or selected by the end-user. The various criteria by which reviewers are auto-filtered may be determined by the individual review as well as the client and template for that review. The set of customizable filter and selection criteria include, but are not limited to, the following:
State License requirements determined by the review data.
Reviewer specialty matching including similar specialty groups. For example, if the review calls for Endocrinology, depending on the client and template setup, Internal Medicine may also satisfy the requirement.
Clinical hours per week which, for example, allows for selecting only practicing physicians.
Quality Scoring (Reviewers are assigned quality scores after reviewing a review). This average quality score can be used to filter the list of available reviewers during dispatching to eliminate low-quality reviewers or give priority to high-quality reviewers.
Customizable sub-networks based on skillset or specific certification (such as a grouping of reviewers who are all FAA certified).
Review throughput (Reviewers have a minimum and maximum number of reviews the can perform per month and this can be used when assigning reviewers). For example, a reviewer that is over his maximum number of reviews for the month can be excluded from the list of available reviewers, and likewise, a reviewer who is under his minimum can be given priority over other reviewers.
Availability based on day of the week and the specific reviewer's schedule.

Also, while dispatching users have the ability to view reviewer profiles which include contact info, schedules, availability, areas of sub-specialization, average quality, and any reviewer notes.

### Dispatch Scheduling

Dispatch scheduling may allow delayed reviewer assignments based on reviewer groups. As reviewers are assigned to reviews, they may be placed in one of an unlimited number of reviewer groups with a date/time of when the assignment should become active.

An example group assignment is shown in FIG. 4. Given the group assignments in FIG. 4, all the reviewers in Group 1 may immediately receive a notification that they have been assigned a review. If by 4:00 PM Mar. 16, 2013 the review has not been accepted by any of the reviewers in Group 1, then notification may be sent out to all the reviewers listed in Group 2. Subsequently, if by 8:00 PM on Mar. 16, 2013, if no reviewers from either Group 1 or Group 2 have accepted the review, then notifications may be sent out to all the reviewers in Group 3.

Additionally, if prior to 4:00 PM on Mar. 16, 2013 all of the reviewers in Group 1 have acknowledged the review assignment and yet rejected the review explicitly in the system, Group 2 may be sent notifications immediately as there is no reason for the system to wait until 4 PM. This same timing applies to Group 3 once all the reviewers in Group 1 and Group 2 have rejected the review.

The delays between groups may be automatically defined per template, and may also be changed on a per-case basis. The use of groups, especially in combination with a limited/basic information display mode for the cases, may facilitate a conflict of interest check by the independent reviewers. For example, a reviewer of Group 1 may review limited/basic information of a case to determine whether he/she has a relationship with the original medical personal that would prevent him/her from giving an unbiased review. The view of the limited/basic information may be by making one or more fields “not visible” in accordance with the render process described previously, in an example. The reviewer of Group 1 may explicitly reject a case assignment based on only reviewing the limited/basic information, in which case Group 2 may be notified, but even in the absence of an explicit rejection, Group 2 may still be notified of an available case assignment at a predetermined time.

In an example, scooping may be utilized. When a reviewer is assigned to a review, he/she may login to the system to either accept or reject the review. He/she also may defer the decision until a later time. Once one reviewer has accepted a review, he/she may become the reviewer of record and all other reviewer assignments expire. However, once a reviewer does accept the review, all other assigned reviewers who have not yet responded to the reviewer assignment may see their status for that review as “scooped” to indicate that they were too slow in responding to the review and no longer have the opportunity to accept (or reject it). This may provide feedback and incentive for reviewers to respond as quickly as possible to review assignment notifications. This process also may allow prioritization of reviewers based on reviewer fee bids for each review.

### Automated Alerts

Automated system to perform actions based on logic and filtering. The trigger for an alert may be defined via either SQL query or JavaScript expressions or a combination of both using any exposed field on the review. The alert system may poll at a user-configurable interval (e.g. 1 minute) and may perform the appropriate action on any reviews that satisfy its condition. The actions available may be:
Add a comment to a review and flag it as needing attention
Add a review history entry for a review
Setting values on a review field
Changing the workflow stage of a review
Changing the template for a review
Sending emails via email templates with appropriate review information and attachments
Sending faxes via fax templates with appropriate review information
Sending SMS via SMS templates with appropriate review information
Making an automated phone call
Generating a document using document templates with appropriate review information

### Concurrent Review Process

The system 100 may include a concurrent review process that may allow qualifying reviews to be processed via an alternative process to improve review completion rates and efficiency. The system 100 may define a client, template, or a specific review to be processed via the Concurrent Review Process (CRP). If flagged, the review may be automatically be placed in the CRP queue allowing the system 100 to immediately place these reviews in the queues of CRP-certified reviewers. When a CRP-certified reviewer logs into the Portal, in addition to their standard list of available reviews they may also see a button indicating that one or more CRP cases are available. They do not have any visibility to the CRP queue itself, only the button. Once they click the button the next case in the CRP queue may be automatically assigned to them. The reviewer may not accept any other reviews until the current review is completed. The reviewer may not save their work and come back at a later time to complete it, they must complete the review in one session or the review will revert back to the CRP queue. The review, once processed by the reviewer, may then be made available for a final quality assurance and completed. Thus, the CRP system significantly improves both review completion rates and reviewer processing efficiency by identifying simple-structure reviews and bypassing steps that are unnecessary to their completion.

### Review Field Instant Saving

As each field is changed on a review it may be instantly saved to the database. This may prevent data loss and allows all users viewing a review to have up to date information. As a field is changed, any other template fields that reference the saving field in a JavaScript expression may be evaluated. Any such fields, known as dependent fields, may be rendered as HTML and sent back to the webpage. This HTML can be an actual visible field or simply a placeholder for a non-visible field. This allows fields to show/hide or simply update based on field changes in real time without having to reload the entire review webpage resulting in quicker data entry.

In addition, before a field change is committed to the database, the system 100 first may check if the value has already been changed in the database by another user. If the value has been changed in the database, a pop-up may be shown to the user that asks whether to save the user changed value or to revert to the changed database value. In either review, as the review has been changed by another user, the entire review may be reloaded in order to get up to date information in all fields on the review. As a user is viewing a review the system checks at an interval threshold, for example every minute, for other users viewing the same review and if found, may display an alert with all other users who are in the review at the same time. This check may also occur upon initial loading of the review so that a user can clearly see who else is working on that same review, whether it be a client, reviewer, or staff member. This system may allow multiple users to work on a single review concurrently as each field immediately updates and saves.

The entire lifecycle of a field instant save in an example is shown in the flowchart labeled “Review Field Save Overview” shown in FIG. 5.

### Review Auditing

Each review may have a complete audit of all actions taken on the review by any user or automated system. The audit may include:
Field History
   Each field on a review has a complete field history of all the data changes made to that review by any user or system. This history is visible by clicking on the field history icon next to each field. Any log entry can be used to replace the current value of that field.
   The user may use this feature to revert to an earlier saved value in the field, or also to see a differential analysis of the current field contents vs. the previous contents.
Review History
   Every action or data change made to a review is logged to an audit, including but not limited to:
      file attachments
      reviewer assignment
      document generation
      email messaging
      workflow stage changes
      field data changes
   Review History is filterable by user role (reviewer, client, staff, etc.), action type, and user.
Document archive
   Document files are created at every workflow stage change for a review to provide an additional level of history for a review. These documents are also template configurable to provide different formats and information for each review.
Review Ownership
   At each workflow stage of a review, a user is recorded automatically as the owner of that stage which is displayed on the review along with the date and time that the ownership was assigned.
Review Usage
   User time spent in each workflow stage of a review (viewing or editing) is logged and reported upon.

### Document Acceptance Methods

Reviews may require documentation from clients and the Portal provides for several methods for clients to attach documents to reviews, such as Fax (Clients able to fax in document pages which are then attached to a review), Email, (Clients able to email documents which are then attached to a review), Web upload (Clients are able to upload files directly to a review via the website), and SFTP (Clients are able to upload files via SFTP which are then attached to a review).

### Automated Credentialing

The system 100 may track and manage provider credentials. This management may include:
Database keeps track of all credentialing elements as well as expiration dates and re-check dates
Automated alerts based on approaching expiration dates
Automated re-issuing of professional questions
Automatic verification of state licenses

### Reviewer Management

Reviewers may be managed directly within the system. Key points for Reviewer Management may include:
Quality scoring for Reviewers
   Upon completing a review a reviewer is assigned a quality score based on several factors. A reviewer's average quality score is used and displayed throughout the system in order to identify high and low quality reviewers.
   As the system evaluates average quality there are automated triggers for retention, retraining notifications, probationary status, reviewer priority status changes, exclusion from network and any number of other notifications or changes.
Color coding for reviewers based on customizable rules
While being selected for a review (dispatching), a reviewer will have different indicators of their quality, availability, review throughput, Review-In-Training, and bandwidth. These indicators take the form of different color fonts as well as icon indicators when showing the reviewers in any list to facilitate dispatching decision making.
Automated measurement, notification, and comparison to performance standards for the following metrics
   on-time delivery
   call contact success
   quality
   support tickets relating to reviewer
   support tickets created by reviewer
Reviewers can see their billing info in real-time prior to and after invoicing. The information includes:
   Hours accrued current month
   Hours accrued last month
   Reviews completed this month
   Reviews completed last month
   Reviews completed all time

### Portal Shortcuts

Allow users to utilize a private library of frequently used text in order to be speed up processing. This shortcut library may be available for any free-form text field visible to the user and is accessible directly on the field being edited. This shortcut text may be appended to the field value. A reviewer may manage his or her library directly from the review screen while editing fields.

A shortcut entry may be global for all fields or tied to a specific section or review field.

In addition to a reviewer's private library of shortcuts, there may be a public shortcut library with commonly used text that may be either global or assigned to a specific template. This public library may be managed by staff and may also use review field variables in the same manner as the various JavaScript expression enabled fields throughout the system. This may allow a text shortcut to use the value of one or more separate fields on the review when used by a reviewer. For example, when a reviewer is writing a rationale, he may select a public shortcut that reads “Recommend denial based on the amount of {medication_field} being prescribed. {medication_field_dosage} is over the normal limit for such cases.” When appending to the current field, the values in bold may be replaced by the values in the fields referenced within (“Lantus” and “60 units” for example).

A reviewer may copy any public shortcut (including review field variables) to his private library in order to edit the text.

The system 100 may have access to all shortcut libraries and also has reporting access to all shortcut entries to identify trends and as part of its internal quality improvement initiatives.

### Staff Management

Staff may be managed directly within the system. The key areas of staff management may include:
Quality scoring for Staff
   Upon completing a review stage, such as Peer Review, a staff member is assigned a quality score based on several factors. A staff member's average quality score is used and displayed throughout the system in order to identify high and low quality staff.
   As the system evaluates average quality there are automated triggers for retraining notifications, probationary status, and any number of other notifications or changes.
Rotation management
   Rotations define areas of responsibility for staff, such as dispatching. This allows different groups of staff to be assigned different responsibilities within the system to maximize throughput. These rotations, and the users assigned to them, can be managed via the Admin section, provided the user has the appropriate security privileges. Any number of rotations can be created and managed in this manner. Rotations can also be managed via the Staff Rotation widget on the user dashboard.
Team management
   Groups of staff can be grouped together in teams. Each team can have one or more team leads defined in the system. Teams provide a way of logically grouping staff.
Department-specific dashboards with live data widgets which can be inserted, repositioned, deleted from a user's dashboard page. Any number of widgets can be created as the request of users and widgets include, and widget access is controlled via security privileges. The widgets include:
   Commissions
      Widget: Unusual commission rates (potential problem data)
      Widget: Sales Rep Commissions, Last 12 months (charted over time)
      Widget: Commissions by Sales Type, Last 12 months (charted over time)
      Widget: Clients without Commissions (potential problem data)
   Operations
      Widget: Operation Statics Summary, overall system metrics by stage and time, as well as color coding based on minimum and maximum thresholds
         Reviews in each stage
         Flagged reviews in each stage (flagged are reviews that require attention based on client or reviewer changes)
         Reviews currently overdue to the Client
         Reviews received today
         Reviews due to the Client today
         Reviews due to the Client next business day
         Reviews overdue from Reviewer
         Reviews received this month
         Reviews completed today
      Widget: Operations Staff Statistics, filterable list of staff to include the following metrics
         Reviews submitted from each staff stage
         Productivity score
         Productivity is a weighted score that is used to compare review throughput regardless of difficulty of stage (some stages take less time than others to complete)
         Average quality scores per stage
         Current Productivity score goal for user and percentage complete of that goal
      Widget: Rotation Status
         Displays and manages staff rotation assignment.
         Shows whether a user is logged into the system or not
         Color coded icons to indicate whether a rotation is understaffed either from not enough staff being assigned, or not enough staff are currently logged into the system based on a user-definable requirement for each rotation
      Widget: Team status
         List of staff members, their team, rotation, and whether they are logged in or not.
         Allows assigning staff schedules, either as a selectable list of user-defined schedules or as a one-time edited schedule. Can filter to see who is scheduled to work until a certain time that day.
      Sales
         Widget: New Reviews Today, summary of clients and reviews submitted today
         Widget: Top Performers, list of the top sales person according to different configurable metrics such as Completed Revenue Today, or Completed Reviews This Quarter
         Widget: Complete Review Tracking, summary of revenue and number of reviews over time, including goals for the same time period and percentage of goal achieved
         Today
         This Month
         This Quarter
         This Week
         This Year
         Widget: Clients to Watch, user-selectable list of Clients to track revenue and number of reviews over time
         Widget: Client Invoiced History, billing metrics for selectable client over selectable time period
         Total number of reviews
         Total revenue
         Total profit
         Avg. revenue per review
         Avg. profit per review
         Widget: New Clients, list of new clients and their metrics based on a selectable time period
         Widget: Top 10 Clients, top clients based on revenue or number of reviews over a selectable time period
      Billing
         Widget: Active Reviews, this and last month (chart)
         # Reviews
         # Reviews with Billing Notes
         Re-opened reviews
         Widget: Active Clients, this and last month (chart)
         # Clients
         # Client with Volume Discounts
         # Clients with Resubmissions
         Widget: Running Charges per Billing Period (invoice month)
         Widget: Previously Invoiced Re-opened reviews (require special attention from billing staff)
         Widget: Cancelled Reviews (list of cancelled reviews)
         Widget: Volume Discount Warnings (notice of charges that have potential issues due to volume discounts)
Staff productivity enhancements due to color indicator for reviews based on customizable rules, such as:
   Reviews due today
   Reviews due tomorrow
   Reviews past-due
Production projection tool based on staffing and productivity using the staff Productivity Scoring and current Rotation.
   Each staff rotation has a weight factor for difficulty of completing a single review while in that rotation. Using this rotation weight factor as well as the staff member's average productivity score, the system can calculate how many reviews each staff member should be able to complete in a day. Using the individual throughput, a total system-wide throughput can be calculated based on rotation assignment.
Automated Portal-based “Emergency Plan” to change staffing and responsibilities when review-queues reach certain thresholds. All staff are notified via system-level announcement pop-ups and tickers when these plans are in effect
Security based privileges
Each staff member has a collection of user privileges that grant or deny access to system functions (such as editing Client information, or renaming a report)

### Client Management

Clients may be managed directly within the system. The key areas of client management may include:
Ability to create multi-level sub-categorizations within clients
Ability to define custom reviewer attestation statements (typically regarding a lack of conflict of interest) that show when a reviewer first opens a review to accept or reject it.
Draft stage to save partially completed requests for medical review to be completed at a later time. Draft is special workflow stage that allows clients to work on a review prior to submission for processing.
Ability to have multi-stage submissions (different individuals at client complete different parts of web form).
Designation of specific client types with automated indicators on client lists as well as in review lists:
   New clients are automatically designated as New Client Reviews (NCR) and flagged appropriately
   NCR status automatically counts the numbers reviews submitted by that client.
Ability to define custom access levels (roles) for different client users
   View
   Admin
   Supervisor
   User
Ability for client to update reviews while review being processed after submission. Able to add comments to a review as well as create support tickets related to that review.
Ability to re-open closed reviews for further processing. This triggers different billing logic depending on whether the review has been previously invoiced among other factors.
Client self-management capability. Client users, depending on access level, have the ability to manage themselves, including:
   Update their user profile (time zone, regional settings, preferences)
   Change their user name and password (which includes enforcement of client configurable password rules such as length and how often a password can repeat)
   Adding/removing/editing users for the client, including role changes

Customizable automatic inactivity logout may be based on different state and federal security requirements such as HIPAA. Some clients may require that their users be logged out after a first time period, e.g. only 15 minutes of inactivity, while others will use a different time period, e.g. 30 minutes, which may be a default inactivity timeout. Activity may be defined as any mouse movement or keyboard press on any system webpage (all open tabs will synchronize their activity). After the period of inactivity the user may be presented with a countdown timer explaining that they will be logged out in a threshold time, say 1 minute, and they must click a button requesting to stay signed in or be logged out with a message as to why.

### Reviewer not to Exceed Time for Automated Billing

System 100 may automatically determine how much total time a reviewer (or cosigner) should reasonably take to perform a review based on calculation taking into account multiple factors including:
Number of documentation pages to review
Number of questions to answer for review
Type of review
Complexity of review
Review type
Client
Whether additional phone calls or communication is required with the original provider
Client customization adjustments

The calculation may customizable per client and per template. The formula weight values for each of these criteria may be routinely measured and adjusted for the most accurate calculation of maximum reviewer time allowable. If the reviewer attempts to enter a total review time greater than the NTE time, a validation message may be displayed instructing the reviewer to adjust his or her time accordingly. This NTE time may apply to all reviewers and cosigners and there are separately calculated values for each reviewer role.

### Automated Billing

Automated billing system that affords comprehensive rate negotiation with clients. As a result of these negotiations, rate structures may be defined in the system 100, applied to individual or multiple clients, and then used to automatically generate invoice charges for reviews.

The system 100 may allows the following configurable features by client or template:
The ability to assign different rates to a review based on review complexity, as defined by size of review and estimated time for completion.
The ability to define categories of reviews on two levels. Depending on what category or categories a review is assigned to, it will relate to a different billing rate structure.
The ability to apply discounts based on number of reviews processed for a monthly invoice, total charge amount for a monthly invoice, and/or lateness criteria.
The ability to define and utilize both flat rates and hourly rates for a billing structure. When both hourly and flat rates might be used for a review depending on its complexity, charges are always generated to ensure that the more complex the review is, the greater the charge is. If an hourly rate calculation on its own generates a smaller charge than a flat charge would for a simpler review, the charge is automatically increased to reflect its appropriate place in the billing structure.
The ability to assign a full rate structure to more than one client.
The ability to write complex conditional statements (using JavaScript expressions and review field variables) to assign reviews to specific billing group categories or generate specifically negotiated discounting criteria.
HIPAA compliance variations per client
Monthly vs. per review invoicing
Invoice format customization using invoice templates

The Automated Billing may contain a commission system that may automatically run on a monthly basis, collecting invoice and payment information from an external accounting system, summarizing the information on a client-by-client basis, and calculating commissions to be paid to all relevant sales representatives for those clients.

A specialized calculation system may be used that may pay out commissions to sales representatives on a percentage basis based on gross profits for new clients, but for older, established clients (at least 2 years old), commissions may be based on business growth rather than gross profit. For these older clients, a “baseline profit” may be calculated by finding the average gross profit for the three months leading up to the clients' last business anniversary dates; any profits exceeding these baseline profits on a monthly basis may be considered commissionable, thereby emphasizing the importance of growing business over simple maintenance.

This system 100 may generate commissions historically. As client payments arrive, the system 100 may identify which invoice(s) the payments relate to, figure out which sales representative(s) were assigned at the time of the invoicing, calculate a baseline profit to exceed—if relevant—based on the time of the invoice, and then may calculate the commissions accordingly. Thus, no matter how sales representative assignments might change over time or how late payments might be for old invoices, the system 100 may calculate commissions for the correct sales representatives for the correct amounts with historical accuracy.

The commission system may be managed via a separate Commission section where all the appropriate commissions rates and assignments are defined.

The Automated Billing system also may have a two-way integration with external accounting software to synchronize payments and invoicing between the two systems.

### Re-Open Completed Reviews

Review processing may follow a strict beginning-to-end methodology that organizes the involvement of clients, staff, and reviewers, provides concrete and predictable results to clients, sends charge invoices, and pays reviewers. However, there are times when a review might need to be re-opened after completion based on newly acquired data or requirements. To handle these situations, the review re-open feature keeps a cumulative summary of work done for reviews as they get completed and re-opened while maintaining a high-resolution history of client invoices and reviewer payments.

The system may allow both clients and staff to re-open a completed review, provide information about the rationale for doing so, and provide parameters for the new work required. The system then may re-open the review, sends it to the appropriate party for processing, and store a historical record of the review at time of re-opening. The system may have the capability to handle as many completions and re-openings as necessary for a given review.

Client invoicing and contributor payments may be handled in cumulative fashion. The review itself may represent overall work done and time spent across all completions and re-openings; however, an individual invoicing information may be provided to clients on a completion-by-completion basis such that the client always knows what work was done and how much money may be charged for each completion. Similarly, reviewers may be paid on a completion-by-completion basis, and different reviewers may be involved for different completions on the same review. FIGS. 6A-6H illustrate an example of re-opening completed reviews.

### Core Network Billing

Core Network Billing is meant to ensure reviewers are provided with reliable and accurate workloads. This system 100 may utilize a definable workload value for each reviewer—defined in terms of number of hours per week. In a given month, every time a reviewer works, a priority value may be calculated and assigned to that reviewer; the priority value may be high if the reviewer is far away from his or her workload goal, and as the reviewer gets closer the priority may lower. These priority values may be used as part of the reviewer assignment process (dispatching); when a review is ready to be assigned to a reviewer, those with the highest priority values may be given the first opportunity to accept the review. Thus, this automated system may significantly boost the probability of reviewers comfortably reaching their workload goals.

When reviewers exceed their workload values, their priority level may drop, and their compensation may be discounted automatically, incentivizing reviewers to keep their workload estimations accurate and not take work that should otherwise go to reviewers who haven't yet reached their workload quotas.

### Bidirectional API for Integrating with Client Systems

### Incoming

The Review API may allow clients to submit reviews and make changes to existing reviews via a secure application programming interface (API). The API may accept review-specific information from the client and may generate a new review within the Portal system. Based on the area of review, the API may automatically assign a review to a particular review template allowing clients to submit to a variety of different review types automatically. Cancellation requests may also be accepted via the API and if the review is in a cancellable state, the review may be cancelled and notifications may be sent to the appropriate parties. All changes made via the API may be logged and may appear in the review and field histories.

### Outgoing

Upon completion of reviews that are flagged as part of an automated workflow, the system 100 may submit the review to the API Queue Monitor. The API Queue Monitor service may monitor a queue for newly added entries and for each entry and may automatically submit the required review data back to the client's API.

### Copy Review

A duplicate is able to be made of any review depending on template definition.

Clients, due to the nature of their business, may submit reviews that are very similar in structure, requiring the same information on duplicate reviews (to be processed by several independent reviewers for example). The “Copy Review” feature may allow staff to select a review and create a new one that shares the same information.

Upon invoking the Copy Review feature, an interface may be shown that lists the fields of the currently selected review (e.g., which information is required for and utilized by the review) and may allow the user to select or deselect from many of the fields to copy to the new review. (Note that some fields aren't selectable, as they are either required to be copied or irrelevant based on the type of review the copy is drawn from.) Once the fields are selected, the user may then, by the click of a button, create a new review that automatically may contain the field values based the original review. In short, this feature may save time and improves efficiency by allowing the creation of new reviews based on existing reviews rather than requiring each review to be entered from scratch.

In each template field definition, there is a “copyable” property that may allow that field value to be copied when duplicating a review. Fields may default to always being copied or may be simply allowed to be selected by the user when duplicating a review.

In an example, a review may include a physician or other medical professional performing a review on a case submitted by a client (or review). In an example, a review may include a medical case submitted by a client. In an example, dispatching may include the process of assigning potential reviewers to work on a review. In an example, a template may include a configurable structure for a review, assigning potential reviewers to work on a review. In an example, a client may include a company or entity that submits reviews for processing. In an example, a submitter may include a client end-user who is able to log into the Client Portal and submit reviews for processing. In an example, a stage may include a single step along the review workflow (such as “Dispatching” or “Complete”). In an example, a workflow may include a set of steps through which a review must pass (some steps may be optional). In an example, the term credentialing may refer to a process of establishing the qualifications of licensed medical professionals. In an example, the term Widget may refer to a small light-weight user-configurable user-interface component designed to be used next to other components on a containing dashboard page to provide a single set of information or functionality.

In an example, a memory device may be provided. The memory device may have instructions stored thereon that, in response to execution by a processing device, cause the processing device to perform operations including storing a plurality of fields for forming an electronic medical review form; storing a plurality of templates, wherein a first one of the templates comprises a first set or subset of the fields of the plurality, and a second one of the templates comprises a second set or subset of the fields of the plurality, wherein the second set or subset is different than the first set or subset; selecting a template of the plurality of templates; and generating a web page using fields of the selected template.

In an example, the operations further comprise retrieving one of the fields of the selected template; determining whether to render the retrieved field; and in response to determining to render the retrieved field, selecting an attribute from a plurality of fields and rendering the retrieved field based on the selected attribute.

In an example, the operations further comprise determining whether a last field of the selected template has been retrieved; in response to determining that the last field of selected template has not been retrieved, retrieving a next field of the selected template; determining whether to render the retrieved next field; and in response to determining to render to retrieved next field, selecting the same or different attribute from the plurality of attributes and rendering the retrieved field based on the selected same or different attribute. In an example, the plurality of attributes includes at least one of a read only attribute, a required field attribute, or a validator attribute.

In an example, the operations further comprise, after determining whether to render the last field, receiving a user input from a remote web browser; identifying one of the fields of the selected template that corresponds to the received user input; and parsing code corresponding to the identified field.

In an example, the operations further comprise, responsive to parsing the code, determining whether other field(s) of the selected template is/are dependent on the identified field; and, in response to determining that other field(s) of the selected template is/are dependent on the identified field, parsing code corresponding to each of the other field(s).

In an example, the operations further comprise, responsive to parsing the code corresponding to each of the other field(s), determining whether to parse code based on dependencies of the other field(s).

In an example, the operations further comprise, responsive to receiving the user input, selectively re-rending the fields of the selected template.

In an example, the operations further comprise, for each re-rendered field of the selectively re-rendered fields, determining whether to re-render as label only; and responsive to determining to not re-render as label only, re-render data as a label.

In an example, the operations further comprise, for each re-rendered field of the selectively re-rendered fields that is not re-rendered as label only, rendering data of said re-rendered field as a label or selecting an editor from a plurality of editors and performing the re-rending of said field based on the selected editor. In an example, the plurality of editors includes at least one of a numeric editor, a date editor, a text editor, or a timespan editor.

In an example, the operations further comprise storing a plurality of review stage types; wherein a first stage type of the plurality corresponds to a first party, a second stage type of the plurality corresponds to a second party that is different than the first party, and a third stage type of the plurality corresponds to a third party that is different than the first party and the second party; and forming a workflow definition responsive to receiving a user input for a custom workflow, the workflow definition data identifying selected ones of the stage types of the plurality and a selected order for executing a process based on the selected ones of the stage types of the plurality. In an example, the first party comprises staff of the medical review organization, the second party comprises a client of the medical review organization, and the third party comprises professionals that are independent of the staff. In an example, at least one stage of the plurality comprises a dispatch stage to select at least one individual of the third party, and wherein the dispatch stage comprises filtering, to select a subset from a set of medical professionals based on a parameter set by the second party. In an example, the dispatch stage further comprises grouping, to divide the subset resulting from the filtering into a plurality of groups based on a parameter set by the first party. In an example, the dispatch stage further comprises scheduling, including notifying members of a first group of the plurality at a first time regarding a review assignment and notifying the members of a second group of the plurality that is different than the first group at a second time that is different than the first time. In an example, the second time is the earlier of a fixed date and time or a date and time that every member of the first group explicitly rejects the review assignment. In an example, the plurality comprises review stage types of an extensible set, and wherein the workflow definition data is based on an extensible set version that corresponds to a time of receipt of the user input.

In an example, the operations may further comprise associating the workflow definition data with the selected template; retrieving a field of the selected template; and determining whether to render the retrieved field on a per-stage basis.

In an example, the operations further comprise, in response to determining to render the retrieved field, selecting an attribute from a plurality of fields, wherein the selection is based on which stage of the plurality of review stage types corresponds to a current stage; and rendering the retrieved field based on the selected attribute.

It will be obvious to those having skill in the art that many changes may be made to the details of the above-described embodiments without departing from the underlying principles of the invention. The scope of the present invention should, therefore, be determined only by the following claims.

Most of the equipment discussed above comprises hardware and associated software. For example, the typical electronic device is likely to include one or more processors and software executable on those processors to carry out the operations described. We use the term software herein in its commonly understood sense to refer to programs or routines (subroutines, objects, plug-ins, etc.), as well as data, usable by a machine or processor. As is well known, computer programs generally comprise instructions that are stored in machine-readable or computer-readable storage media. Some embodiments of the present invention may include executable programs or instructions that are stored in machine-readable or computer-readable storage media, such as a digital memory. We do not imply that a “computer” in the conventional sense is required in any particular embodiment. For example, various processors, embedded or otherwise, may be used in equipment such as the components described herein.

Memory for storing software again is well known. In some embodiments, memory associated with a given processor may be stored in the same physical device as the processor (“on-board” memory); for example, RAM or FLASH memory disposed within an integrated circuit microprocessor or the like. In other examples, the memory comprises an independent device, such as an external disk drive, storage array, or portable FLASH key fob. In such cases, the memory becomes “associated” with the digital processor when the two are operatively coupled together, or in communication with each other, for example by an I/O port, network connection, etc. such that the processor can read a file stored on the memory. Associated memory may be “read only” by design (ROM) or by virtue of permission settings, or not. Other examples include but are not limited to WORM, EPROM, EEPROM, FLASH, etc. Those technologies often are implemented in solid state semiconductor devices. Other memories may comprise moving parts, such as a conventional rotating disk drive. All such memories are “machine readable” or “computer-readable” and may be used to store executable instructions for implementing the functions described herein.

A “software product” refers to a memory device in which a series of executable instructions are stored in a machine-readable form so that a suitable machine or processor, with appropriate access to the software product, can execute the instructions to carry out a process implemented by the instructions. Software products are sometimes used to distribute software. Any type of machine-readable memory, including without limitation those summarized above, may be used to make a software product. That said, it is also known that software can be distributed via electronic transmission (“download”), in which case there typically will be a corresponding software product at the transmitting end of the transmission, or the receiving end, or both.

Having described and illustrated the principles of the invention in a preferred embodiment thereof, it should be apparent that the invention may be modified in arrangement and detail without departing from such principles. We claim all modifications and variations coming within the spirit and scope of the following claims.

1. A memory device having instructions stored thereon that, in response to execution by a processing device, cause the processing device to perform operations comprising:
storing a plurality of fields for forming an electronic medical review form;
storing a plurality of templates, wherein a first one of the templates comprises a first set or subset of the fields of the plurality, and a second one of the templates comprises a second set or subset of the fields of the plurality, wherein the second set or subset is different than the first set or subset;
selecting a template of the plurality of templates; and
generating a web page using fields of the selected template.
